(19) United States
(12) Patent Application Publication
(10) Pub. No.: US 2015/0339603 A1
(43) Pub. Date: Nov. 26, 2015

(54) METHOD AND APPARAUTS FOR MAPPING PROCESS INFORMATION ONTO ASSET DATA

(71) Applicant: THOMSON LICENSING, Issy de Moulineaux (FR)

(72) Inventor: Mark Leroy WALKER, Castaic, CA (US)

(73) Assignee: Thomson Licensing

(21) Appl. No.: 14/652,701

(22) PCT Filed: Dec. 20, 2013
(86) PCT No.: PCT/US2013/077204

§ 371 Date: Jun. 16, 2015

Related U.S. Application Data
(60) Provisional application No. 61/755,892, filed on Jan. 23, 2013.
(60) Provisional application No. 61/833,770, filed on Jun. 11, 2013.

(51) Int. Cl. G06Q 10/06

(52) U.S. Cl. CPC G06Q 10/0633

(57) ABSTRACT

Asset-driven work flow dependency management establishes connections between activities based on the descriptions of the assets used as inputs and/or outputs for each activity. These descriptive “contracts” enable readily matching relevant activities to create a desired output. The graphical model can be used to design and track real world productions. Graphical representations of activities are used to model venders, facilities and other production activities. The activity models produce and/or consume assets that represent the deliverables that are transferred between activities. Using the models of activities, a model of the production pipeline can be built from back to front. Thus, a final result activity model is selected first and based on the assets required by the selected final result activity an appropriate activity that produces that required asset can be selected. This process can be repeated until the beginning of a process pipeline is reached.

### REFERENCE TO RELATED APPLICATIONS

This application claims the benefit of U.S. Provisional Application Ser. No. 61/755,892 filed Jan. 23, 2013 and U.S. Provisional Application Ser. No. 61/833,770 filed Jun. 11, 2013 which are incorporated by reference herein in their entirety.

This application is also related to the applications entitled: “SET HANDLING IN ASSET-DRIVEN WORFLOW MODELING”, “FULFILMENT TRACKING IN ASSET-DRIVEN WORFLOW MODELING”, and “ASSET-DRIVEN WORFLOW MODELING” which have been filed concurrently and are incorporated by reference herein in their entirety.

### TECHNICAL FIELD

This invention relates to modeling workflow and/or production pipelines, and more particularly to a method and apparatus for modeling a production pipeline based on the assets required and produced along the production pipeline.

### BACKGROUND

For any movie, television, or record production, there are several assets such, a shots, visual effects, sound, etc that are in several different formats are that transferred between different productions companies which may produce new assets in new formats. These assets are the building blocks used to make a television show, movie, record, or the like. Keeping track of such assets and knowing what the location and state of the assets is a tremendously complicated endeavor.

Project manager programs exist but they are typically designed for a top down static system design where each block representing a stage of the project is associated to the next block by the user to create the system. Blocks do not link together based on assets nor do the programs track such assets.

Thus, a method and system that can model a workflow and/or a production pipeline based on assets used in the production of a movie, television, music album, etc. is needed.

### BRIEF SUMMARY

Asset-driven workflow dependency management establishes connections between activities based on the descriptions of the assets used as inputs and/or outputs for each activity. These descriptive “contracts” provide a mechanism to readily match relevant activities necessary to create a desired output. By creating a graphical model of desired workflow a user is provided with a better understanding of what is involved in the workflow as well as where issues and redundancies may occur. The graphical model can be used to design and track real world productions.

Graphical representations of activities are used to model venders, facilities and other production activities. The activity models produce and/or consume assets that represent the deliverables that are transferred between activities. Using the models of activities, a model of the production pipeline can be built from back to front. Thus, a final result activity model is selected first and based on the assets required by the selected final result activity an appropriate activity that produces that required asset can be selected. This process can be repeated until the beginning of a process pipeline is reached. A real world process pipeline can then be formed based on the model and the model can be used to track the status of the real world production pipeline. In order to prevent duplication and redundancy a workflow model can be created based on already existing assets.

One embodiment of the disclosure provides a method for modeling a workflow. The method includes the steps of determining that an asset required for a workflow already exists and providing a graphical representation of an activity that involves the existing asset.

Another embodiment of the disclosure provides an apparatus for modeling a workflow. The apparatus includes storage, memory and a processor. The storage and memory are for storing data. The processor is configured to determine that an asset required for a workflow already exists and provide a graphical representation of an activity that involves the existing asset.

Objects and advantages will be realized and attained by means of the elements and couplings particularly pointed out in the claims. It is important to note that the embodiments disclosed are only examples of the many advantageous uses of the innovative teachings herein. It is to be understood that both the foregoing general description and the following detailed description are exemplary and explanatory and are not restrictive of the invention, as claimed. Moreover, some statements may apply to some inventive features but not to others. In general, unless otherwise indicated, singular elements may be in plural and vice versa with no loss of generality. In the drawings, like numerals refer to like parts through several views.

### BRIEF SUMMARY OF THE DRAWINGS

FIG. 1 depicts a block schematic diagram of a system in which asset-driven workflow modeling can be implemented according to an embodiment.

FIG. 2 depicts a block schematic diagram of an electronic device for implementing the methodology asset-driven workflow modeling according to an embodiment.

FIG. 3 depicts a block schematic diagram of an asset-driven workflow model according to an embodiment.

FIG. 4 depicts an exemplary flowchart of a methodology for asset-driven workflow modeling according to an embodiment.

FIG. 5 depicts an exemplary diagram illustrating the steps of the flowchart of FIG. 4 according to an embodiment.

FIG. 6 depicts a block schematic diagram of an asset-driven workflow model implementing sets according to an embodiment.

FIG. 7 depicts an exemplary diagram of graphical representations of activities according to an embodiment.

FIG. 8 depicts an exemplary diagram of the matching of activities based on asset descriptors according to an embodiment.

FIG. 9 depicts an exemplary diagram of the matching of activity templates and activity instances based on asset descriptors according to an embodiment.

FIG. 10 depicts a table of exemplary asset descriptors and their matching based on parameters according to an embodiment.

FIGS. 11A and 11B depicts an exemplary diagram of the propagation of parameters of asset descriptors according to an embodiment.

FIG. 12 depicts an exemplary flowchart of a methodology for providing status of assets in asset-driven workflow modeling according to an embodiment.

FIG. 13 depicts an exemplary diagram illustrating the steps of the flowchart of FIG. 12 according to an embodiment.

FIG. 14 depicts an exemplary diagram of asset tracking involving shared facilities according to an embodiment.

FIG. 15 depicts an exemplary diagram illustrating the relationship between assets, activities, venders, and facilities according to an embodiment.

FIG. 16 depicts an exemplary flowchart of a methodology for mapping process information on to asset data according to an embodiment.

FIG. 17 depicts an exemplary diagram illustrating the steps of the flowchart of FIG. 16 according to an embodiment.

FIG. 18 depicts an exemplary screenshot of a producers workspace according to an embodiment.

FIG. 19 depicts an isolated screenshot of the deliverables dashboard of the producer workspace of FIG. 18 according to an embodiment.

FIG. 20 depicts an isolated screenshot of the filtered pipeline of the producer workspace of FIG. 18 according to an embodiment.

FIG. 21 depicts an isolated screenshot of the activities details of the producer workspace of FIG. 18 according to an embodiment.

FIG. 22 depicts an exemplary screenshot of a manager workspace according to an embodiment.

FIG. 23 depicts an exemplary screenshot of a data I/O workspace according to an embodiment.

FIG. 24 depicts an exemplary screenshot of an executive workspace according to an embodiment.

FIG. 25 depicts an exemplary screenshot of a pipeline builder according to an embodiment.

### DETAILED DESCRIPTION

Turning now to FIG. 1, a block diagram of an embodiment of a system 100 for implementing asset driven workflow modeling is provided. The system includes a server 110 and one or more electronic devices such as: smart phones 120; personal computers (PCs) 130, such as desktops or laptops; and tablets 140 in communication with the server 110 over the internet 150. In certain embodiments, the server 110 provides the environment, including processing and storage, for the asset driven workflow modeling. Users interface with the asset driven workflow model on the server 110 using a browser or application on the electronic devices such as smart phones 120, PCs 130, or tablets 140. In other embodiments, part, or all, of the asset driven workflow modeling can be performed on the one or more electronic devices such as: smart phones 120; personal computers (PCs) 130, such as desktops or laptops; and tablets 140.

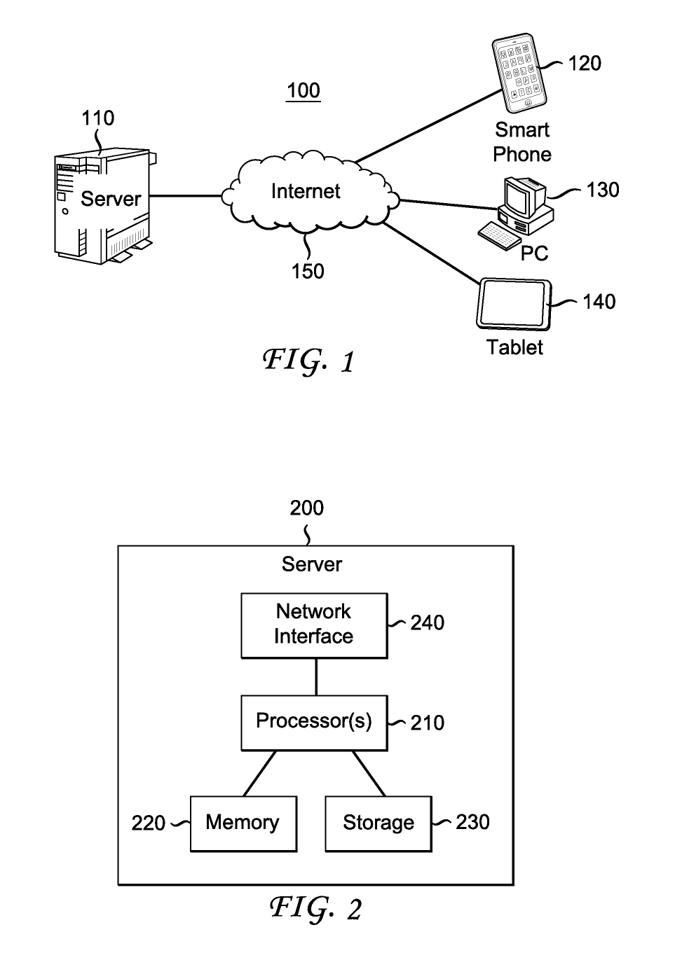

FIG. 2 depicts an exemplary server 200, or electronic device, that can be used to implement the methodology and system for asset driven workflow modeling. The server or electronic device includes one or more processors 210, memory 220, storage 230, and a network interface 240. Each of these elements will be discussed in more detail below.

The processor 210 controls the operation of the server 200 or electronic device. The processor 210 runs the software that operates the server or electronic device as well as provides the functionality of the asset driven workflow modeling application. The processor 210 is connected to memory 220, storage 230, and network interface 240, and handles the transfer and processing of information between these elements. The processor 210 can be general processor or a processor dedicated for a specific functionality. In certain embodiments there can be multiple processors.

The memory 220 is where the instructions and data to be executed by the processor are stored. The memory 220 can include volatile memory (RAM), non-volatile memory (EEPROM), or other suitable media.

The storage 230 is where the data used and produced by the processor in executing the cold storage recommendation methodology of the present disclosure is stored. The storage may be magnetic media (hard drive), optical media (CD/DVD-Rom), or flash based storage. Other types of suitable storage will be apparent to one skilled in the art given the benefit of this disclosure.

The network interface 240 handles the communication of the server 200 or electronic device with other devices over a network. Examples of suitable networks include Ethernet networks, Wi-Fi enabled networks, cellular networks, and the like. Other types of suitable networks will be apparent to one skilled in the art given the benefit of the present disclosure.

It should be understood that the elements set forth in FIG. 2 are illustrative. The server 200, or other electronic device, can include any number of elements and certain elements can provide part or all of the functionality of other elements. Other possible implementation will be apparent to on skilled in the art given the benefit of the present disclosure.

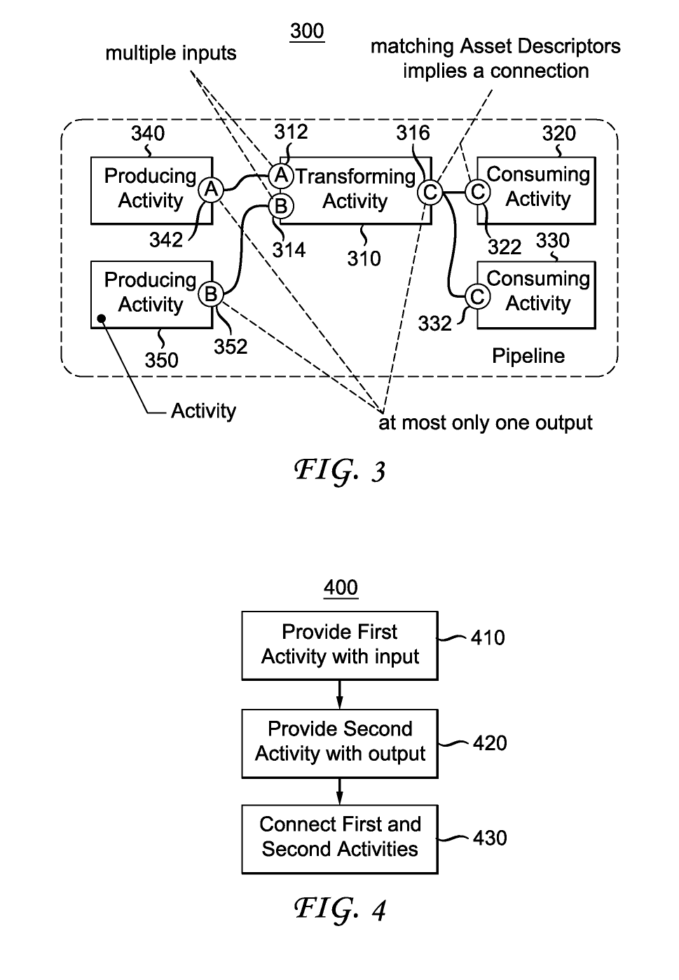

FIG. 3 depicts a graphical model 300 of an asset driven workflow. Asset-driven workflow dependency management establishes connections between activities based on the descriptions of the assets used as inputs and/or outputs for each activity. These descriptors provide a mechanism to readily match relevant activities necessary to create a desired output. FIG. 3 shows that the Transforming Activity 310 requires Asset A and Asset B as inputs 312, 314 and will create Asset C as a result provided on output 316. The Consuming Activities 320, 330 expect Asset C on the inputs 322, 332 while both Producing activities 340, 350 bring Assets A and B into the modeled system on outputs 342, 352. In this exemplary Pipeline 300, the outputs 342, 352 of Producing Activities 340 and 350 are connected to the inputs 312, 314 of Transforming Activity 310. The output 316 of Transforming Activity 310 is in turn connected to the inputs 322, 332 of Consuming Activities 320 and 330.

### SOME WORKING DEFINITIONS

Pipeline: A collection of Activities connected together to create a desired output. The pipeline provides a graphical model of the workflow. For example of video or film production, the pipeline represents all the activities (such as generation of data, specific shots, formats, or audio tracks) necessary to produce the desired product.

Activity: An operation that produces, transforms, or consumes Assets (Including deliverables such as data, specific shots, formats, or audio tracks). Each Activity may have inputs, an output or both. As a simplifying assumption, activities typically only have a single output (although the output could be a complex or compound asset). Activities (except for consuming activities) can be easily characterized by their output. What makes an Activity unique is the specific configuration of inputs that are mapped via the Activity to produce a given output. Different Activities may create an identical output and therefore only one would be required within a given Pipeline. The output of a given activity can provide input into multiple downstream Activities.

Connection: when an Activity output description matches one or more input descriptions then a Connection is implied. Connections represent fulfillment agreements or contracts for the delivery and receipt of Assets.

Asset Descriptor: The label of an input/output of and Activity used for matching and establishing connections between Activities.

Further discussion of these concepts is provided later in this document.

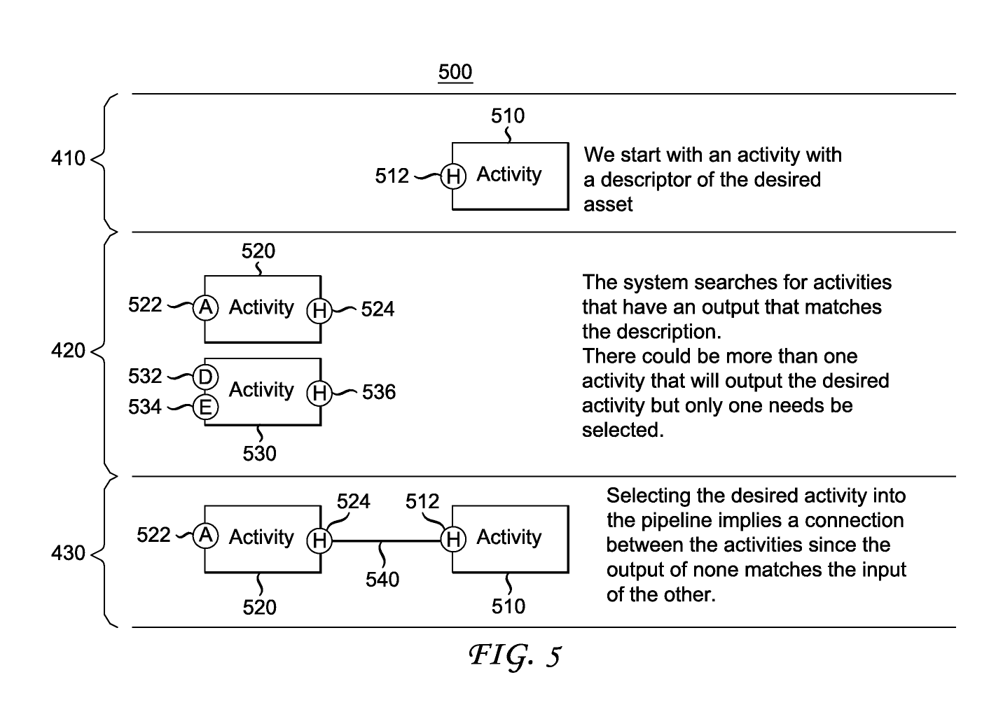

FIG. 4 is a flow diagram 400 of a process for creating a graphical representation of a workflow. At the basis the process involves three steps. Providing a graphical representation of a first activity (step 410) having at least one input with an associated asset descriptor, providing a graphical representation of a second activity having at least one output with an associated asset descriptor matching the asset descriptor of the input of the graphical representation of the first activity (step 420), and graphically connecting the output of the graphical representation of the second activity with the input of the graphical representation of the first activity based on the matching asset descriptors (step 430). A graphical example 500 of these steps can be seen in FIG. 5.

### Modeling the Workflow

Step 410, as shown in graphical example 500 of FIG. 5, starts with providing a graphical representation of a first activity 510. In this embodiment the graphical representation of the first activity has one input 512 with a descriptor of the desired asset (in this case “H”). In other embodiments the graphical representation of the first activity 510 may have multiple inputs with different associated asset descriptors. The provided graphical representation of the first activity may be a graphical representation selected from multiple provided graphical representations of activities. The selection of a graphical representation can be made by user using a graphic user interface or by the system itself based on the desired or required activity. In some circumstances, not all of the activities that can match a specific asset descriptor will be used.

In step 420 of the graphical example 500 of FIG. 5, at least one graphical representation of a second activity is provided. In this example, the system searches for activities that have an output with an associated asset descriptor that matches the asset descriptor (“H”) of the input 512 of the first activity 510. There could be more than one activity that will output the desired activity but only one needs be selected. The selection can be performed by a user or by the system. In this example there are two possible activities 520, 530 that have an output with an as associated asset descriptor that matches the asset descriptor (“H”) of the input 512 of the first activity 510. One possible second activity 520 has an output 524 with a matching asset descriptor (“H”) as well as an input 522 with a different associated asset descriptor (“A”). The other possible second activity 530 having an output 536 with a matching asset descriptor (“H”) has two inputs 532, 534 with different associated asset descriptors (“D” and “H”).

Selecting the desired second activity, in this case activity 520, into the pipeline implies a connection between the activities 510, 520 since the asset descriptor associated with the output of the second activity 520 matches the asset descriptor of the input 512 of the first activity 510. The implied connection is represented in step 430 as a graphical connection 540.

In this embodiment, the matching and connection is based on asset descriptors not the asset itself. This allows for the creation of a complete pipeline model before actual assets exist. Some benefits of such asset driven modeling include: explicit mapping of activities based on the descriptions of assets they output or consume, provenance of assets can be traced explicitly through the system, and downstream dependencies can be easily calculated.

### Workflow/Pipeline Modeling (Sets)

In the world of media production it is common to encounter activities which produce a number of like elements as part of larger set. For example a “Dailies” activity is responsible for converting video and audio “shots” captured on-set into an easily reviewable format for the director or producer to review and approve.

As an example: the Dailies activity might be responsible to process 1000 “shots” over a period of a few weeks. Furthermore these “shots” may come from different camera units in a non-sequential fashion. The output of the “Dailies” activity is regularly passed through to the next step on a daily basis.

For the modeling of such a system, the use of sets may be beneficial. Set are collections of one or more assets that are of the same type. Each member of the set is a unique asset but is of the same type or class as the other assets in the set. For example, a set may consist of 500 shots but each member of the set is a shot. Sets can be used to distribute and accumulate work product across multiple activities. Sets can also be divided into sub-sets as well. Hence, an activity might receive different sub-sets from different activities or an activity might only consume a portion of the original produced.

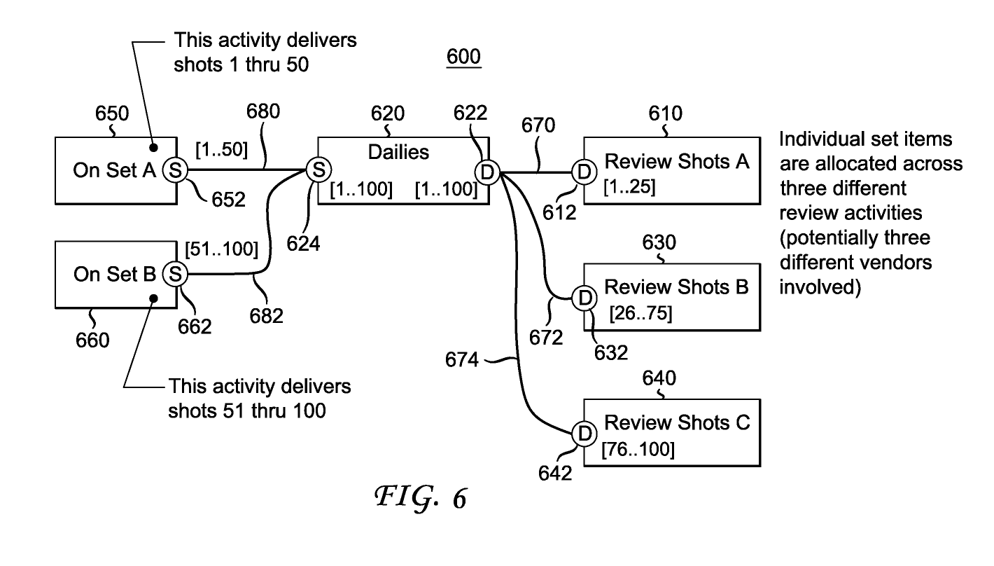

The methodology of modeling a workflow using sets is similar to the methodology for non-set asset driven modeling as set forth in FIG. 4. First and second activities are provided and connected based on the associated asset descriptors. However in this case, the asset descriptors indicate that sets of assets are being used. An example of this can be seen in the workflow model 600 of FIG. 6.

In the workflow model 600 of FIG. 6 a graphical representation of a first activity 610 is provided. The first activity 610 is a consuming activity and has an input 612 with an associated asset descriptor (in this case “D”). In this example, the asset descriptor further indicates there is a set of assets (in this case, shots 1-25) that is expected to be received at the input 612. A graphical representation of a second activity 620 is also provided. The second activity 620 is a transforming activity and has an output 622 with a matching associated asset descriptor (“D”). However, in this case the asset descriptor indicates that there is a larger set of assets (shots 1-100) that is to be provided on the output 622. However, since some of the member assets of each set match a connection is implied and indicated graphically 670.

In the embodiment of FIG. 6, graphical representations of a third 630 and forth 640 activities are also provided. The third and forth activities are consuming activities with inputs 632, 642 having associate asset descriptors (“D”) which further indicate the inputs 632, 642 are to receive sets of activities. In the case of the third activity 630, the set comprises shots 26-75. In the case of the forth activity 640, the set comprises shots 76-100. Since the sets of the third and forth activity 630, 640 are subsets of the set of the second activity 620, there are matching members of the respective sets and a connection is implied between the second activity 620 and the third activity 630 as well as between the second activity 620 and the forth activity 640 which are indicated graphically 672, 674.

As set forth previously, the second activity 620 in the model 600 of FIG. 6 is a transforming activity. As such, the second activity 620 further includes an input 624 with and associated asset descriptor (in this case, “S”). In this example, the associated asset descriptor further indicates that there is a set of assets (in this case, shots 1-100) expected to be received on the input 624. Thus, the second activity 620 models a process, or operator that receives a set of assets “S” comprising shots 1-100 on its input 624 and produces a set of assets “D” comprising shots 1-100 on its output 622.

Graphical representations of a fifth activity 650 and sixth activity 660 are also provided in the model 600 of FIG. 6. The fifth activity 650 and sixth activity 660 are producing activities with outputs 652, 662 having associate asset descriptors (“S”) which further indicate the inputs 652, 662 are to produce sets of activities. In the case of the Fifth activity 650, the set comprises shots 1-50. In the case of the sixth activity 660, the set comprises shots 50-100. Since the sets of the fifth and sixth activity 650, 660 are subsets of the set to be received on the input 624 of the second activity 620, there are matching members of the respective sets and a connection is implied between the fifth activity 650 and the second activity 620 as well as between the sixth activity 660 and the second activity 620 which are indicated graphically 680, 682.

### Asset Descriptors

As can be seen, asset descriptors are used to model inputs and outputs to create connections between activities and identify potential activity connections. In certain embodiments the asset descriptors can be used to correlate with existing assets in an asset registry.

In certain embodiments asset descriptors can be used for exact or parameterized matching, where parameterized matching provides some wildcard-like capabilities when descriptors are compared. In the present examples, a fully defined asset descriptor is denoted with a capital letter in a circle, for example:

[symbol]

A parameterized asset descriptor can be denoted with a capital letter “primed” in a circle. For example:

[symbol]

### Some More Definitions:

Activity Instance. Is an activity where all input and output asset descriptors are fully defined, meaning there are no undefined parameters.
Activity Template. Is an activity having one or more parameterized asset descriptor to facilitate reuse. This, however, is not a requirement.

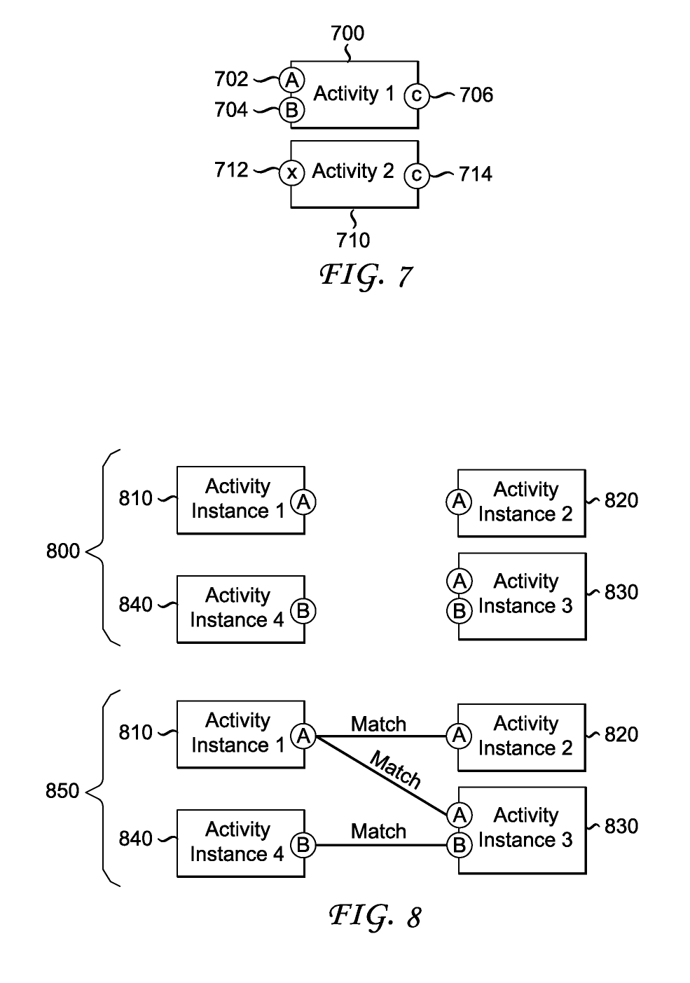

Activities are defined in terms of their inputs and outputs. Inputs and outputs are defined, in-turn, by their asset descriptors. The specific combination of inputs and outputs determines the “signature” of the activity (regardless of what it might be named). In the example of FIG. 7, Activity 1 700 takes an asset (A) and an asset (B) at the inputs 702, 704 and provides and asset (C) at the output 706. Activity 2 710 provides an asset (C) at the output but takes asset (X) at the input 712. In this example, each of these activities is unique in that they require different inputs but both produce the same output.

To model a connection between activity instances the output of an upstream activity needs to match the input of a downstream activity. Multiple downstream activities may consume the same asset. In the first model 800 of FIG. 8, there is an Activity Instance 1 (810), Activity Instance 2 (820), Activity Instance 3 (830), and Activity Instance 4 (840). In the second model 850 the connections are shown with Activity Instance 1 (810) providing asset (A) to instances 2 (820) and 3 (830). Activity Instance 3 (830) requires two inputs (A) and (B). Asset (B) is provided by Activity Instance 4 (840).

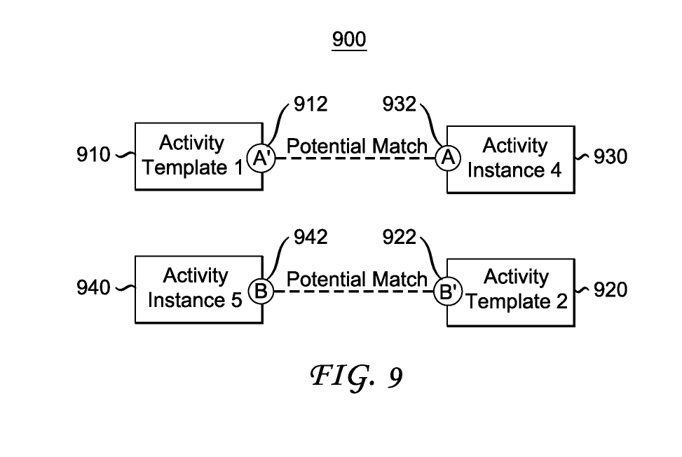

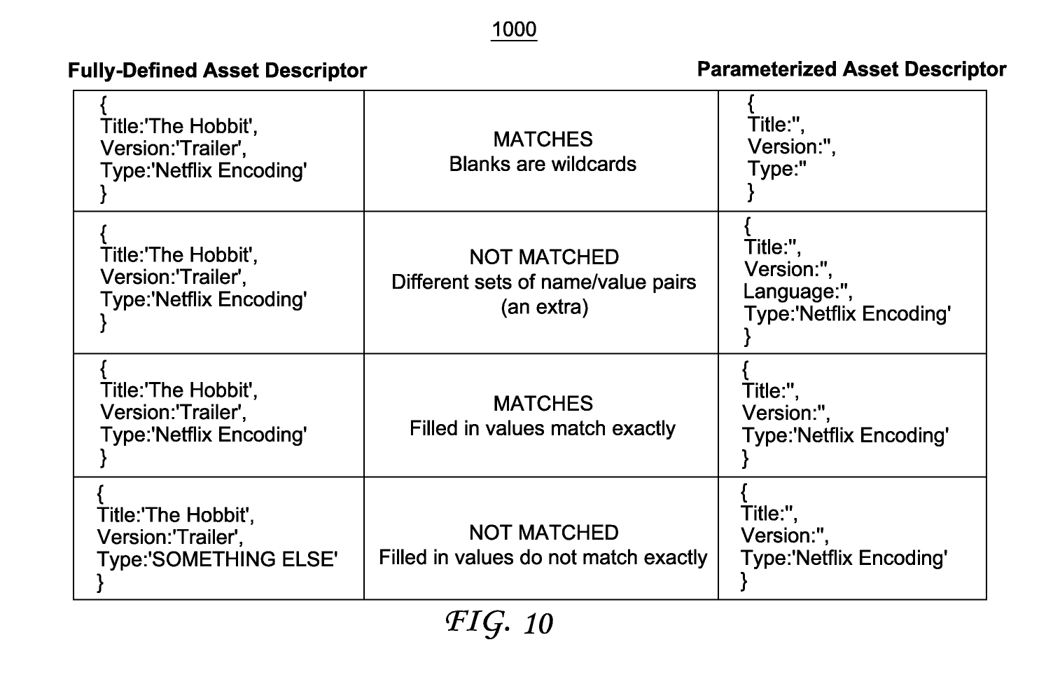

To model a potential connection between an Activity Instance with an Activity Template the Input of the instance can do a template match with the output of the template (or vice-versa). An example of this can be seen in model 900 of FIG. 9. In FIG. 9, the asset descriptor (A) of the input 932 of Activity Instance 4 (930) matches the asset descriptor (A′) of the output 912 of Activity Template 1 (910) and the asset descriptor (B) on the output 942 of Activity Instance 5 (940) matches the asset descriptor (B′) of the input 922 of Activity Template 2 (920).

Using single letters up to this point was one approach to illustrate the disclosed concepts at a high level. In practice there are an arbitrarily large number of ways to describe an asset. One embodiment uses a collection of name/value pairs in order to provide a human readable and flexible mechanism for creating Asset Descriptors. An Asset Descriptor can be comprised of one or more name/value pairs taken as a whole to describe the asset General Asset Descriptor format:

```
{
      name1:value1,
      name2:value2,
      name3:value3,
      ...
}
```

### Example

```
{
      Title:‘The Hobbit’,
      Version:‘Trailer’,
      Type:‘Netflix Encoding’
}
```

A parameterized description simply leaves one or more values blank. In the example below both “Title” and “Version” are parameters.

### Example

```
{
      Title:‘’,
      Version:‘’,
      Type:‘Netflix Encoding’
}
```

Asset Identifiers are normalized versions of the Asset Descriptor. First the Asset Descriptor is normalized so case and name/value pair order do not affect the comparison. To normalize the Asset Descriptor, names and values are forced to lower case (optional) then sorted by name and the result concatenated.

### Example

```
The Asset Descriptor:
{
      Title:‘The Hobbit’,
      Version:‘Trailer’,
      Type:‘Netflix Encoding’
}
```

becomes the Asset Identifier:
title:‘the hobbit’,type:‘netflix encoding’,version:‘trailer’

Optionally a cryptographic hash can be performed on the above result to create a unique numeric (hex) identifier shown below:
147c21 df6e470da7879307dbfb2e2a5d3e9c40719ba2a1a840bf71c732f71b2f
   The cryptographic hash variant of the Asset Identifier is especially useful when identifying user interface elements as a class or id parameter in HTML where the textual version has too many issues to be convenient.

An Asset Reference concatenates the values in the order defined in the original Asset Descriptor separated by an underscore “_” character. This provides a human readable shorthand to less formally describe the asset.

The above example becomes:

‘The Hobbit_Trailer_Netflix Encoding’

Asset Descriptors and Asset Identifiers can both be used for full identification. The Asset Reference, however, is for display convenience only and should not be relied on for unambiguous referencing.

Exact matching of fully-defined Asset Descriptors can be performed directly using the Asset Identifiers.

When matching a fully-defined Asset Descriptor with a parameterized descriptor the following rules are used:
Name/Value pairs are forced to lower case prior to comparison.
The parameterized Asset Descriptor must have exactly the same name entries as the fully defined Asset Descriptor. The order of the names is not significant.
If a parameterized Asset Descriptor entry has a blank for a value then it will match regardless of the corresponding value in the fully-defined Asset Descriptor. If the parameterized Asset Descriptor has a non-blank entry for a value then it must match exactly (after normalization).

Examples are shown the exemplary table 1000 of FIG. 10.

When building a pipeline of activities it should be sufficient to select the desired output (consuming activity), fill in the desired parameter values and then allow the desired values to propagate as activities are identified to complete the pipeline. The example of FIG. 11 details a pipeline 1100 being built from finish-to-start as indicated by arrow 1102.

Pipelines may also be built from start-to-finish or middle-out.

Step 1.0 (1110) of FIG. 11B begins at the end activity. In this example the provided activity is a selected Activity Template 1112 for which the parameters for the asset descriptor “A′” for the input are specified making the Activity Template an Activity Instance. The specified parameters for the asset descriptor “A” can then be passed to a second provided Activity Template 1122 through connection 1114.

In step 2.0 (1120) the specified parameters passed through connection 1114 are used to specify parameters for the asset descriptors (“B′” and “C″”) associated with the inputs of the provided second Activity Template 1122 making the Activity Template an Activity Instance. In this example the parameter of language for asset descriptor “C″” was not passed through because it was already specified.

In step 3.0 (1130) of FIG. 11A, specified parameters from the second Activity Instance are passed through connection 1124 to a provided third Activity Template 1132. The passed specified parameters are used to specify parameters for the asset descriptor “C′” associated with the output of the provided third Activity Template 1132 making the Activity Template an Activity Instance.

In step 4.0 (1140) specified parameters from the second Activity Instance are passed through connection 1126 to a provided forth Activity Template 1142. The passed specified parameters are used to specify parameters for the asset descriptor “B′” associated with the output of the provided forth Activity Template 1142 making the Activity Template an Activity Instance.

In modeling actual content creation and distribution pipelines the following heuristics can prove useful:
All Activity Descriptors should contain a “Title” and “Version”. These differentiate the assets for an entire pipeline instance.
All Activity Descriptors should contain a “Type”. The Type field represents the type of content being produced by an activity (Video, Audio, Digital Cinema Package, etc).
Other useful Asset Descriptor entries are: “Language”, “AspectRatio”, “DubSubOV”, and “Format”. These may or may not be relevant based on the “Type” value. Others entries may evolve into use over time.

### Asset Registry

As the activities and assets of the graphical models discussed herein can often represent real activities or assets it can be beneficial to provide and maintain an Asset Registry. The Asset Registry maps Asset Descriptors (or Asset Identifiers) to the location of actual assets. By registering existing assets against fully defined Asset Descriptors it is possible to eliminate unnecessary activities from the pipeline upon definition.

As a modification to the previously defined pipeline building strategy a step to check the registry can proceed any attempt to match Activity Templates. It is possible to have multiple copies of an asset at different locations mapped to a given Asset Descriptor/Identifier.

### Fulfillment Modeling

In the modeling methodology described herein, activities and their connections are modeled based on asset dependencies (see Asset Descriptors section for details). Each connection between activities represents a logical dependency of the output of one activity to the input of the subsequent activity. In order to trace progress from activity to activity, connections can have a fulfillment status. An exemplary methodology for modeling fulfillment status in a workflow model can be seen in the flowchart 1200 of FIG. 12.

At its simplest, the method involves two steps. The first step (1210) is providing a model of a workflow having at least a graphical representation of a first activity and a graphical representation of a second activity wherein the activities are connected based on matching asset descriptors. The second step (1220) is determining the status of at least one asset indicated by the matching asset descriptors that are the basis of at least the connection between the graphical representations of the first and second activities. The steps are described in more detail below in reference to FIG. 13.

In the diagram 1300 of FIG. 13, a model of workflow is provided as set forth in Step 1210 of the methodology of FIG. 12. In this example, the model includes graphical representations of a first activity 1310 (here a source activity) and a second activity 1320 (here a destination activity). The first 1310 and second 1320 activities are connected 1330 based on matching asset descriptors. A fulfillment status 1340 is then determined for at least one asset indicated by the matching asset descriptors that are the basis of the connection 1330.

The fulfillment status reflects the state of a physical/electronic asset moving from one activity to the next. When an activity has produced the expected output (asset) it is physically/electronically sent to dependent downstream activities so the process can continue. The fulfillment mechanism tracks the state of the asset movement (e.g. pending, sending, received, error). In certain embodiments the fulfillment status can graphically displayed or otherwise indicated as part of the graphical representation of the activities or other elements of the model.

In certain other embodiments, the status of an activity can be determined based on the fulfillment status of the assets being produced and/or consumed by activity. In certain further embodiments the status of the activity can be graphically displayed or otherwise indicated as part of the graphical representation of the activity or other elements of the model.

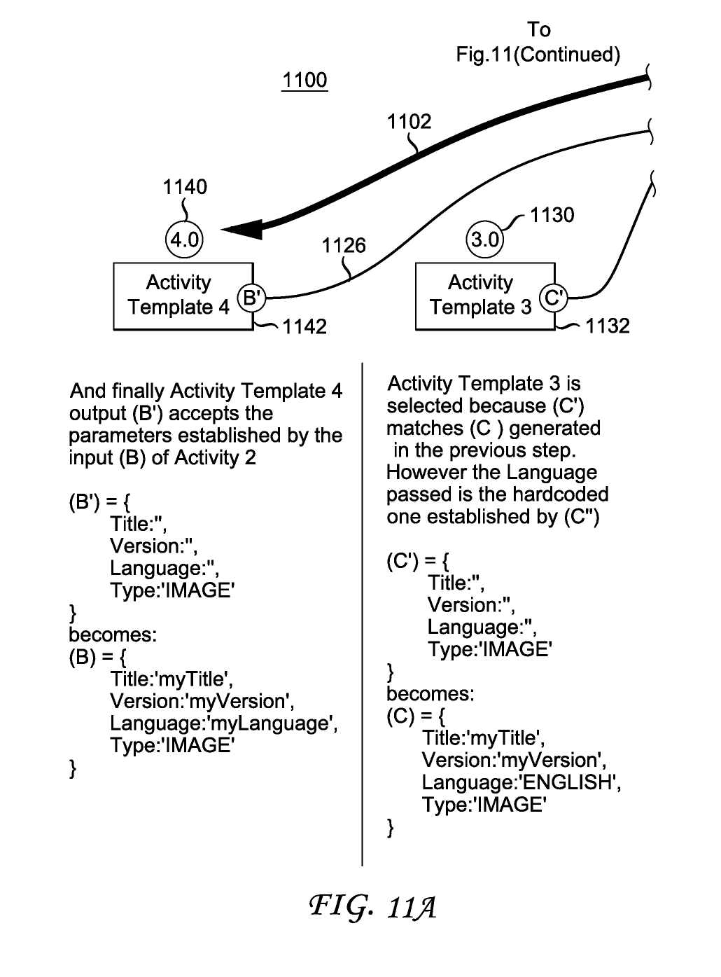

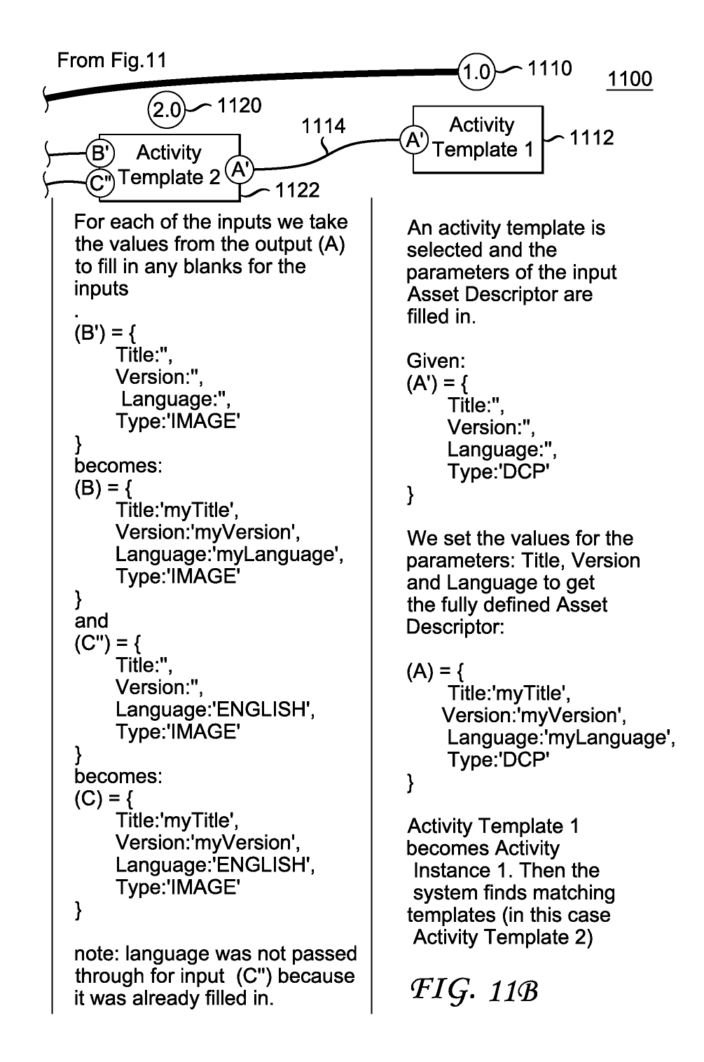

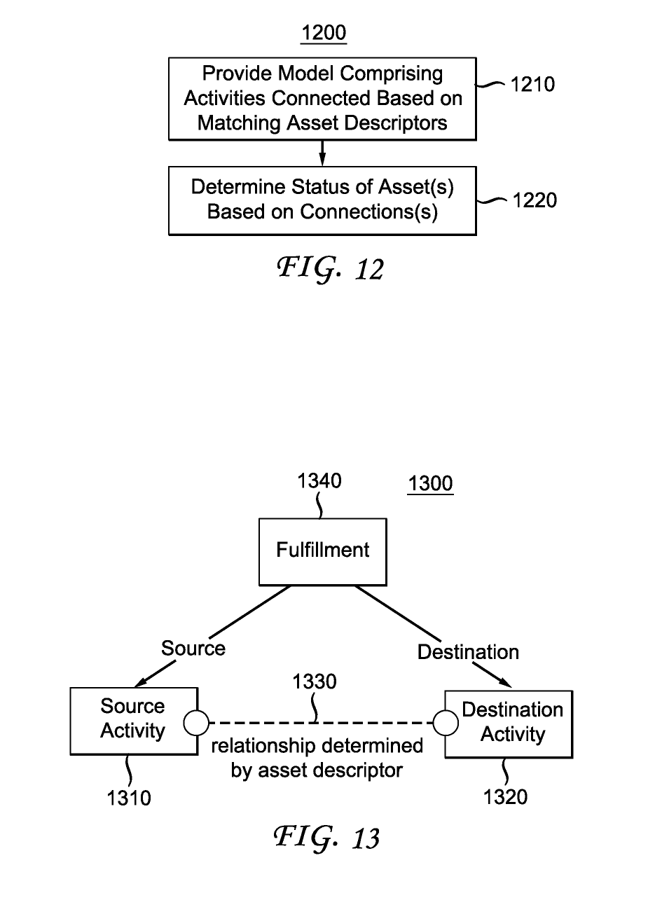

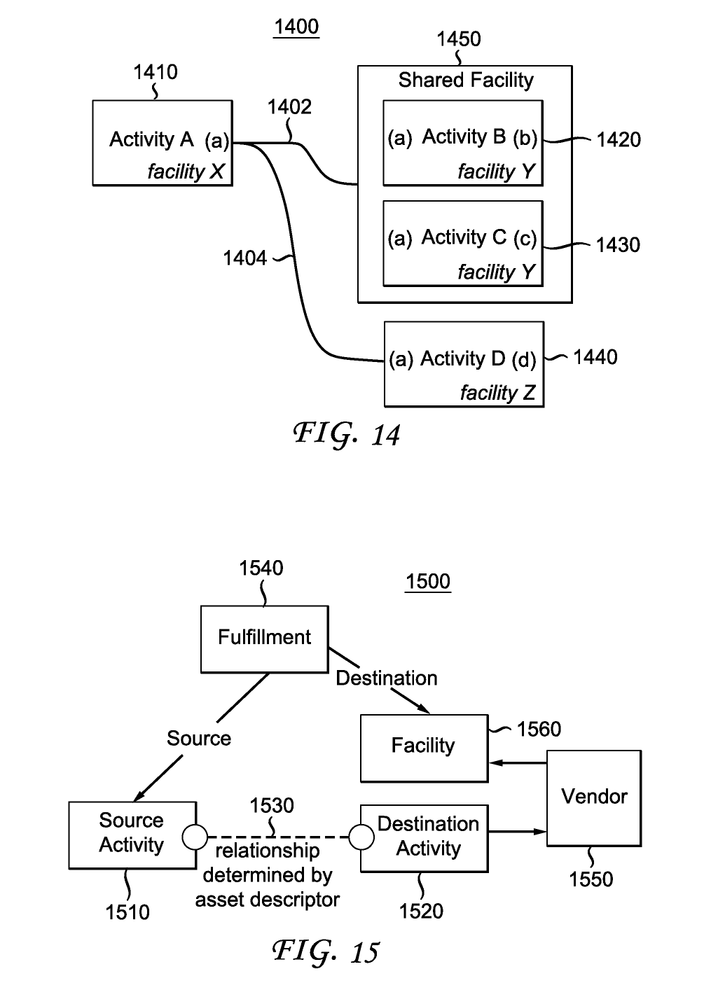

In certain embodiments, a single physical/electronic delivery can be leveraged by multiple downstream activities and multiple fulfillment records would be redundant. To solve this, a change can be made from an activity-to-activity dependency relationship to an activity-to-facility relationship. An example of this can be seen in FIG. 14.

In the exemplary diagram 1400 of FIG. 14, Activity B 1420 and Activity C 1430 are in the same shared facility 1450 (facility Y). Thus a connection 1402 is shown between the source, Activity A 1410 and the shared facility 1450 (facility Y). Destination Activity D is 1440 in a different facility (facility Z) so a separate connection 1404 is provided between Activity A 1410 and Activity D 1440.

The term “facility” has been chosen to differentiate from other “location” references used in the system. In addition the specific asset dependency relationship must still be maintained such that the fulfillment is dependent on not only the facility but also the specific asset that is to be delivered. In such embodiments, a fulfillment status now represents the delivery of a specific asset from a source activity to a facility which, in-turn, may be shared by multiple destination activities. A diagram 1500 of the interaction of these elements can be seen in FIG. 15.

In the diagram 1500 of FIG. 15, a model of workflow is provided. In this example, the model includes graphical representations of a first activity 1510 (here a source activity) and a second activity 1520 (here a destination activity). The relationship 1530 between the first 1510 and second 1520 activities are based on matching asset descriptors. A fulfillment status 1540 is then determined for at least one asset indicated by the matching asset descriptors that are the basis of the relationship 1530. As a practical constraint to this method a facility 1560 is associated with a vendor 1550 which is referenced by the second activity 1520. This way, changing vendor information will result in the appropriate facility assignment. A given facility may be referenced by multiple vendors.

A fulfillment status can be referenced for each pair of activities that share an asset description. When generating the fulfillment status the destination activity's vendor.facility descriptor can be used to determine if a fulfillment has already been created—if so, then the existing fulfillment record can be referenced, otherwise a new fulfillment can be created. In certain embodiments, reverse domain name syntax can be use for the facility descriptor so it's human readable (e.g. technicolor.perivale, technicolor.perivale.transcodingDept). Unique facilities warrant separate fulfillments but there can be multiple “facilities” at the same physical location. This will result in separate records to track fulfillment status independently.

Mapping Process Information onto Asset Data

The workflow modeling, up to this point, has been focused on driving asset creation processes (activities) consistent with the modeled pipeline. That is to say that the system dictated, based on the defined model, what activities depend on what and enforced registration of assets according to the Asset Descriptor scheme. An alternate approach is now provided for delivering a similar level of pipeline information but in a passive manner without direct influence of the underlying activities. The general idea is to overlay a pipeline model (process data) over asset data in order to derive status of the overall process.

When assets are created it is assumed that they are registered in an asset registry system. This methodology would require additional structured data consistent with the concept of Asset Descriptors and Asset Registry described above. The name/values of the asset descriptors would need to be consistent (e.g. titles, language, aspect ratio, etc).

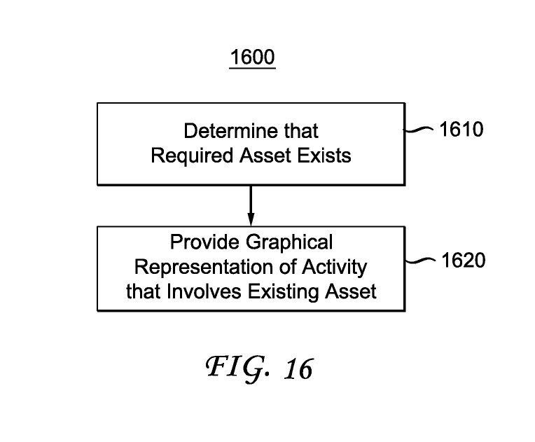

A process model, comprised of activities which in-turn reference Asset Descriptors, would be obtained (perhaps from a process registry) and used to view the data in the asset registry to derive pipeline status information. An example methodology can be seen in the flowchart 1600 of FIG. 16.

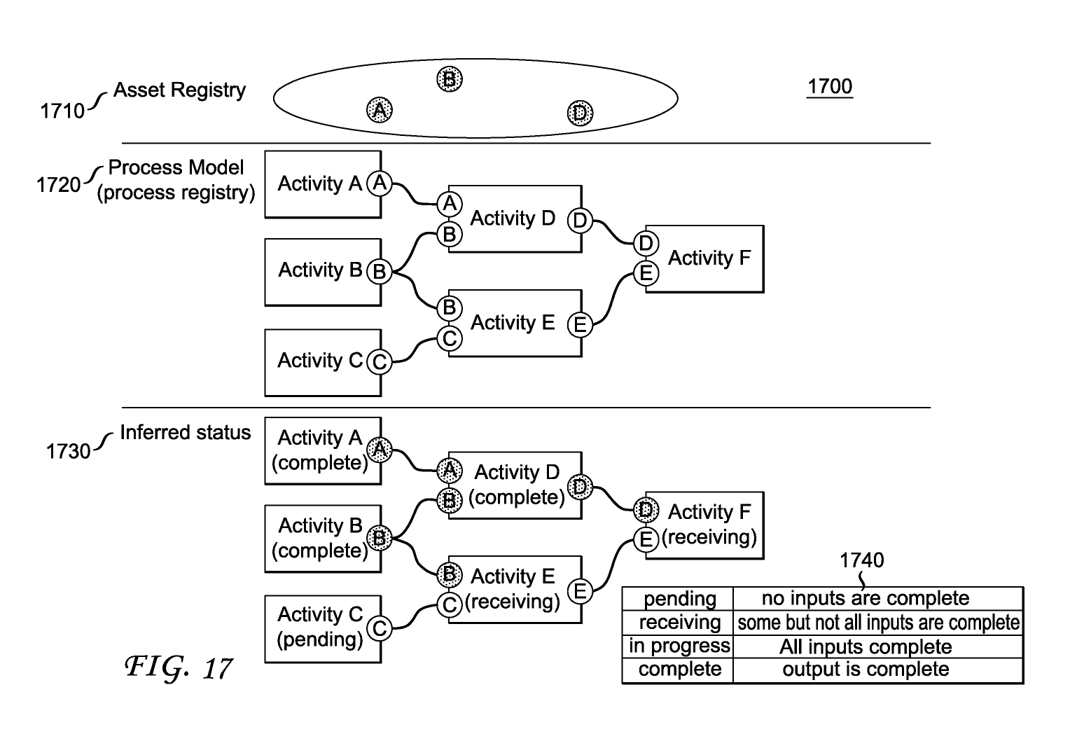

At its simplest, the method involves two steps. The first step (1610) is determining that an asset required for a model of a workflow exists. The second step (1620) is providing a graphical representation of an activity that involves the existing asset. The steps are described in more detail below in reference to FIG. 17.

The diagram 1700 of FIG. 17 has three parts: The asset registry 1710, process model 1720, and inferred status 1730.

It is in the asset registry 1710 that the first step (1610) of is performed. To determine if an asset exists the asset registry is queried. The asset registry is a collection, such as a database, of the assets that have been generated or previously exist. In this example it is assumed the asset registry contains only assets for a given workflow. However, it should be apparent to one skilled in the art that the asset registry could contain any number of registered assets including assets that are not part of the current workflow model. In the example of FIG. 17, it is determined that three assets (A, B, C) already exist.

In the Process Model 1720 of FIG. 17 graphical representations of activities that involve the asset(s) are provided. Such an activity can include the activity that produced or consumes the asset. In certain embodiments, graphical representations of both a producing and a consuming activity, which can be further connected, can be provided. In other embodiments, where there are multiple pre-existing assets, graphical representations of whole pipelines, where all the activities are connected, can be provided. In certain embodiments a process or model registry could be provided. The process registry, like the asset registry, is a collection, such as a database, of pipeline models that have already been created or previously used. In some such embodiments, the registered pipeline models could be matched with or otherwise linked to registered assets in the asset registry.

With Inferred Status 1730, for each activity in the pipeline model the corresponding asset descriptor is queried from the asset registry. If an asset matching the descriptor is found then that activity is assumed to be complete. It is then possible to infer what activities should be in progress by seeing if the inputs to those activities are complete but the output of the current activity is not complete. An example of a status table can be seen at 1740.

Using this basic mechanism, data sets can be approached in a number of ways:

Pre-defined pipeline: In this scenario the specifics of a pipeline are known in advance (i.e. title, version, aspect ratio, etc are defined). This allows for direct mapping to assets in the asset registry. The benefit of this approach is that you can view the status of a pipeline that doesn't have any corresponding activities registered yet.

Infer from existing assets: The system can assume a known pipeline but only for assets that already exist in the registry. As an example, if a translation is received and registered for a specific title, version, language then the system would create an instance for the Acquire Translation activity with the given values then infer the remaining pipeline by matching the output to other activity inputs and in-turn matching the outputs of those activities to the inputs of subsequent activities. The process could happen in an upstream direction as well by matching any inputs of a found activity and following the path of inputs to outputs.

A feature of this method of overlaying process model over existing data is that you can try multiple pipelines as “viewing lenses” to see which pipeline variation matches best.

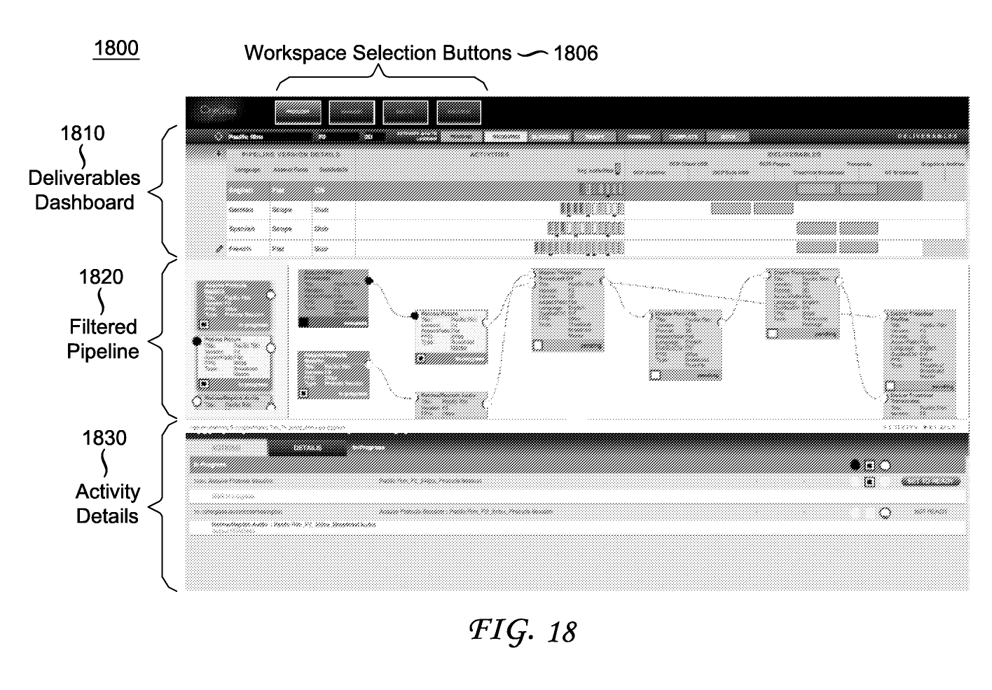

While the previous discussions have focused on creating a model of a workflow and monitoring the status, in certain embodiments it may be advantageous to provide an overview of the pipeline. As such, a user interface may be provided to not only provide a graphical model of the workflow but also provide a high-level perspective of the workflow process. Examples of such a user interface can be seen in FIGS. 18-25. These examples are screen shots that a user can be provided when interacting with the system, such as through a web browser or application on an electronic device.

In accordance with certain embodiments, when the system of the present disclosure is launched, the user will be prompted for credentials and then presented with the producer's workspace as depicted in screen shot 1800 of FIG. 18. This workspace 1800 provides the means for creating entries, viewing status and dependencies along with activity details. A user can also drive the operational process from the activity details panel. The producer's workspace 1800 is comprised of three panels: The Deliverables Dashboard 1810, the Filtered Pipeline View 1820, and the Details View 1830. Other workspace views are available for selection 1802 by the user and are discussed in more detail below.

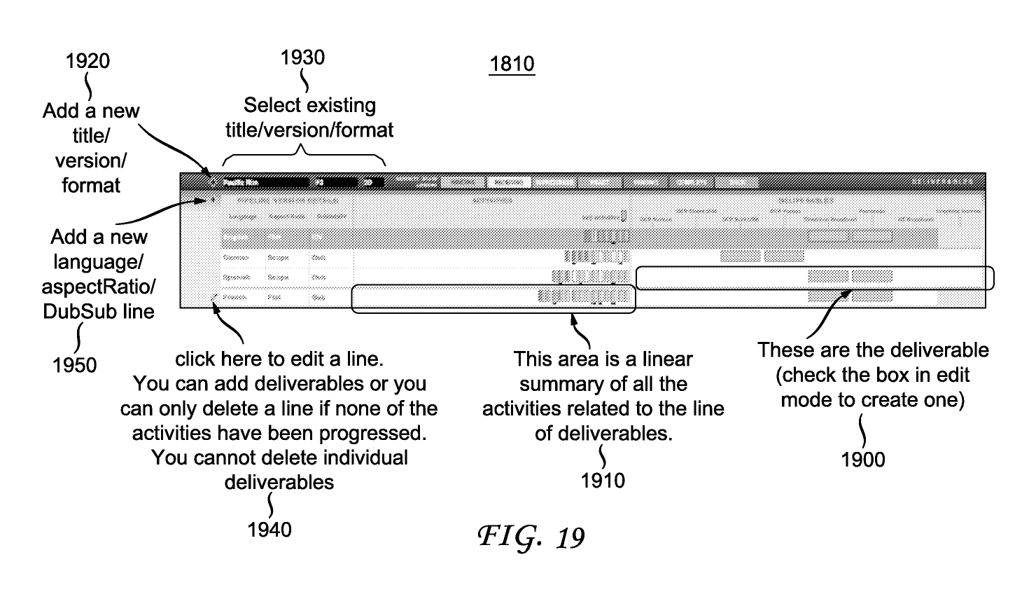

FIG. 19 is an example of the Deliverables Dashboard 1810 of FIG. 18. Each line of the dashboard relates to deliverable 1900 and indicates the activities 1910 associated with the deliverables. The deliverables dashboard 1810 further lets a user add a title/version/format 1920 to the system, select from existing titles/versions/formats 1930, request specific deliveries or add new deliverable 1940, and add a new language/aspect ratio/DubSub line 1950. Entering information here causes the underlying system to build the appropriate pipeline to fulfill the requirement. The system is “smart” enough to know if a particular activity is shared between deliverables.

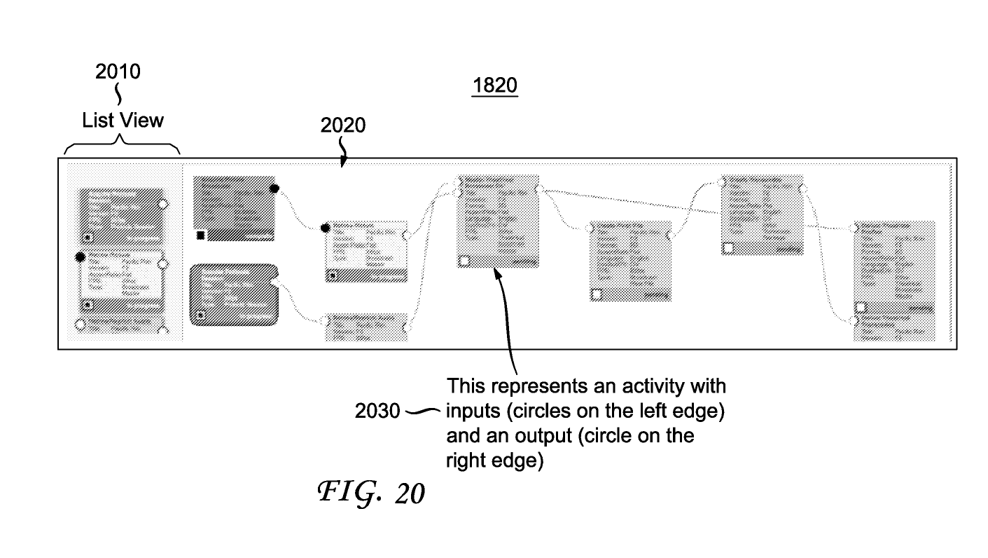

FIG. 20 is an example of the Filtered Pipeline View 1820. The filtered pipeline view 1820 displays a graphic representation of the activities and their interdependencies. The filter pipeline view provides both a list view 2010 and a traditional pipeline model view. The activities shown in this view are related to the row selected in the Deliverables Dashboard. Each activity 2030 is graphically represented as a box with inputs (circles on the left side) and/or outputs (circles on right side). In this embodiment the fulfillment status of assets is indicated by filling-in or otherwise highlighting the inputs and/or outputs indicating an asset has been received or produced. In certain further embodiments the status of an activity can also be graphically indicated. In the present example a box is provided in the bottom left corner which can be filled to indicate status. An empty box means the activity has not started, a partially filled box means the activity is in progress, and a filled box means the activity has been performed.

This panel is also available in the Executive workspace. In that case selecting an activity from the executive panel will display the pipeline relative to activity selected.

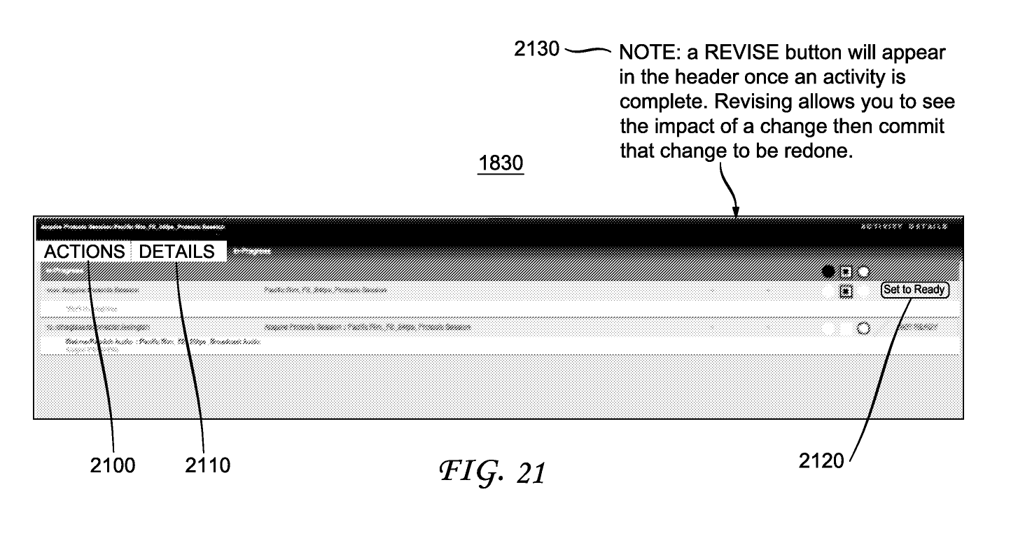

FIG. 21 is an example of the Details View 1830. The detail view panel 1830 provides the ability to update the state of the activity based on three simple actions for which buttons can be provided:
Set to Ready (2120) is used to indicate that activity has been completed.
Send (not shown) to let the system know when the asset has been sent to the next activity or activities
Receive (not shown) to let the system know when an asset has been received from an upstream activity.

In certain embodiments, a Revise action can be provided once an activity has been set to ready. Revising allows a user to see the impact of a change and then commit the change to be redone.

The information provided by these actions can be used to determine the fulfillment status of assets as well as the status of the activities themselves.

In the current display of the details view panel 1830, the actions, indicated by the highlighted “ACTIONS” tab are being displayed. If the “DETAILS” tab is selected, information about due dates and vendor information is displayed. If a date is set and the date is missed (e.g. not done by the due date) the system will flag that as an issue.

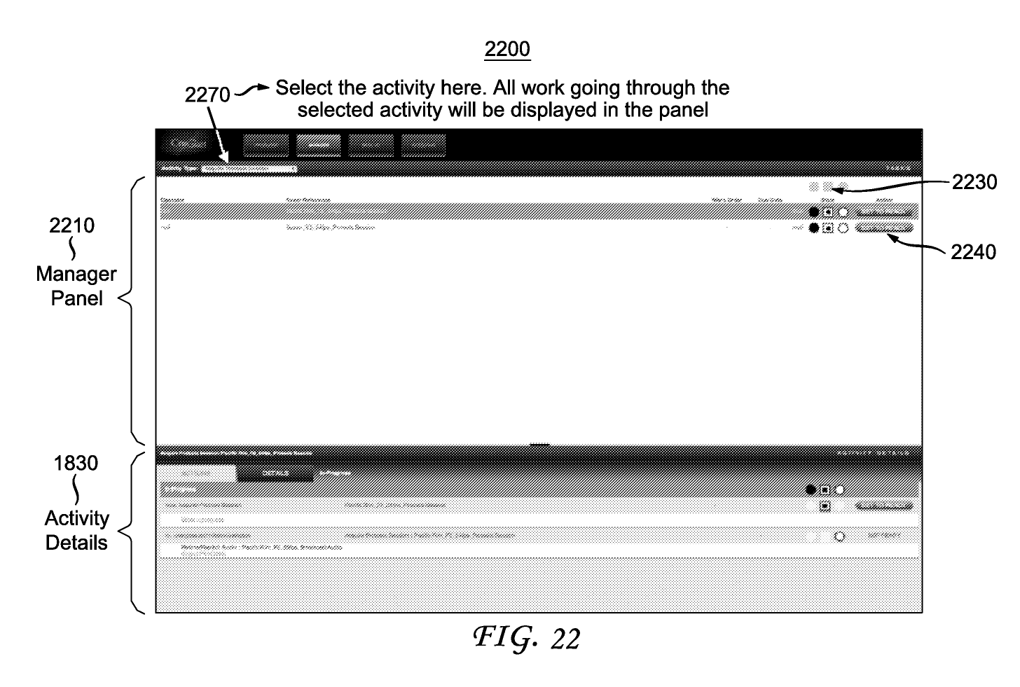

Another possible workspace is the Manager Workspace as depicted in screen shot 2200 of FIG. 22. The manager workspace 2200 is comprised of the manager panel 2210 and the activity detail panel 1830.

The manager panel 2210 presents all work going through a specific activity. The manager panel 2210 allows a user to select a specific activity using field 2220. The work or tasks associated with the selected activity is then displayed in the panel 2210. Filters 2230 can be used adjust what is being displayed. The default filter only shows things that need working on, but filters can be set to show what's coming and what's already been completed.

Once the work is done “Set to Ready” 2240 can be selected and the tasks drop off the board (unless the filters are set otherwise). The activity detail panel 1830 of the manger workspace 2200 operates as described in reference to FIG. 21.

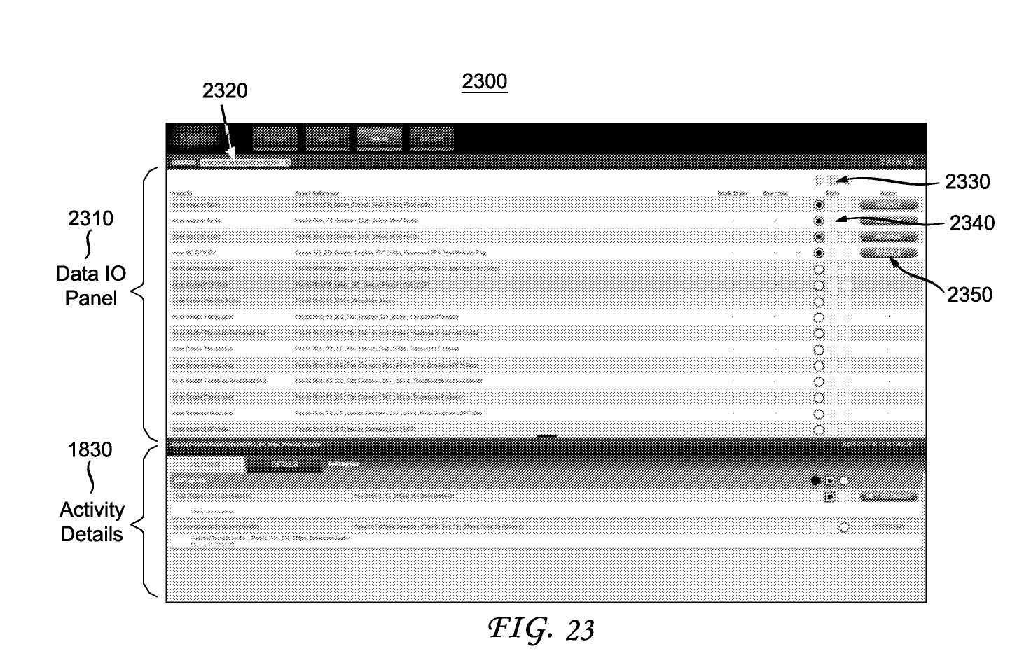

Another possible workspace is the Data I/O Workspace as depicted in screen shot 2300 of FIG. 23. The data I/O workspace 2300 is comprised of the Data I/O Panel 2310 and the Activity Detail Panel 1830.

The data I/O panel 2310 is designed to show all the actions related to a specific facility. It is primarily designed to show send and receive actions to accommodate the idea that people moving assets in and out of a facility may be different from those performing the work creating or modifying assets. The data I/O panel 2310 allows a user to select a specific activity using field 2320. The work or tasks associated with the selected activity, as well as their status 2340, is then displayed in the panel 2310. Filters 2330 can be used adjust what is being displayed. The default filter only shows things that need working on, but filters can be set to show what's coming and what's already been completed. Action such as “Set to Ready”, “Send”, and “Receive” 2350 can be selected and the status 2340 is updated accordingly. The activity detail panel 1830 of the data I/O workspace 2300 operates as described in reference to FIG. 21.

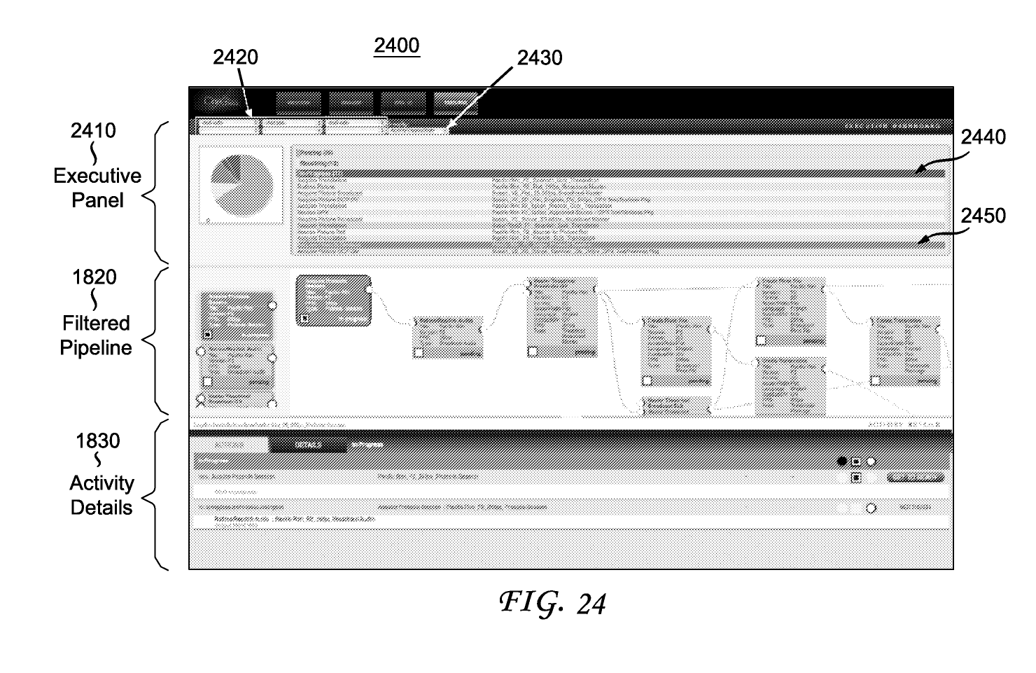

Another possible workspace is the Executive Workspace as depicted in screen shot 2400 of FIG. 24. The executive workspace 2400 is comprised of the Executive Panel 2410, the Filtered Pipeline Panel 1820, and the Activity Detail Panel 1830.

The executive panel 2410 provides overview data such a graphs and task lists. Filters 2420 can be used adjust what is being displayed. In this example, the top box determines what to filter on and the lower box sets the value to use. Results can be grouped using selector 2430. Selecting grouping headers 2440 allows for the groups to be expanded or collapsed. Selecting an item in the panel 2450 caused the related activities and tasks to be displayed in the filtered pipeline panel 1820 and the activity detail panel 1830.

The filtered pipeline panel 1820 of the executive workspace 2200 operates ad describe in reference to FIG. 20. The activity detail panel 1830 of the executive workspace 2200 operates as described in reference to FIG. 21.

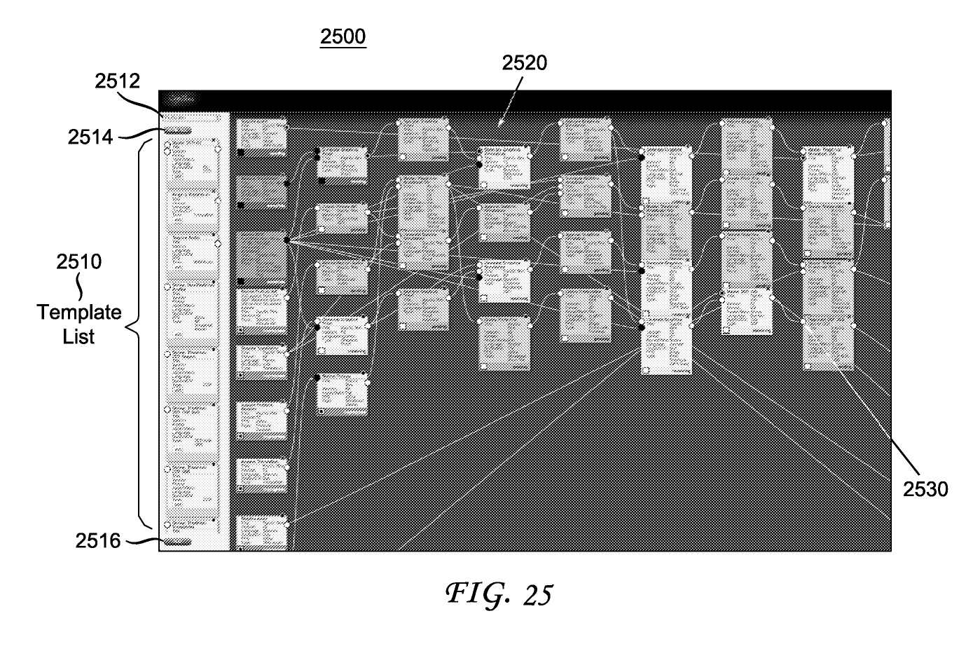

The final exemplary workspace is the Pipeline Builder as depicted in the screenshot 2500 of FIG. 25. The pipeline builder 2500 is comprised of the Template List 2510 and the Workspace 2520.

The template list 2510 provides a field 2512 for selecting a project or workflow. The relevant activity templates for the selected project or workflow are then provided in the template list. These results can further be filtered using the filter functionality 2514. If necessary a new template can be created using a creation tool 2516.

The workspace 2520 provided the functionality for building a pipeline model as discussed throughout this disclosure. In this embodiment, selecting an input or output of a graphical representation of an activity 2530 causes the result in the template list 2510 to be filtered based on the asset descriptors associated with the input or output.

The various embodiments disclosed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for educational purposes to aid the reader in understanding the principles of the embodiments and the concepts contributed by the inventor to furthering the art, and are to be construed as being without limitation to such specifically recited examples and conditions. Moreover, all statements herein reciting principles, aspects, and varies embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

1. A method for modeling a workflow, the method comprising:
determining that an asset required for a workflow already exists; and
providing a graphical representation of an activity that involves the existing asset.

2. The method of claim 1 wherein the step of determining that an asset already exists comprises:
querying an asset registry of existing assets.

3. The method of claim 2 further comprising:
providing an asset registry of existing assets.

4. The method of claim 1 wherein the provided of the graphical representation comprises selecting a graphical representation from multiple possible graphical representations.

5. The method of claim 4, wherein the multiple possible graphical representations are provided as part of a process registry.

6. The method of claim 1 further comprising:
determining the status of the provided activity based on existing asset.

7. The method of claim 1 wherein multiple assets required by the workflow are determined to exist.

8. The method of claim 7 wherein a workflow model that involves the multiple existing assets is provided.

9. An apparatus for modeling a workflow, the apparatus comprising:
a storage for storing workflow information;
a memory for storing data for processing;
a processor configured to determine that an asset required for a workflow already exists and provide a graphical representation of an activity that involves the existing asset.

10. The apparatus of claim 9 further comprising a network connection for connecting to a network.

11. The apparatus of claim 9 wherein the determination that an asset already exists comprises:
querying an asset registry of existing assets.

12. The apparatus of claim 9 wherein the provided graphical representation comprises a graphical representation selected from multiple possible graphical representations.

13. The apparatus of claim 9 wherein multiple assets required by the workflow are determined to exist.

14. The apparatus of claim 13 wherein a workflow model that involves the multiple existing assets is provided.

15. A machine readable medium containing instructions that when executed perform the steps comprising:
determining that an asset required for a workflow already exists; and
providing a graphical representation of an activity that involves the existing asset.
